(19) United States
(12) Patent Application Publication
(10) Pub. No.: US 2023/0004972 A1
(43) Pub. Date: Jan. 5, 2023

(54) Dynamic Question Presentation in Computer-Based Authentication Processes

(71) Applicant: Capital One Services, LLC, McLean, VA (US)

(72) Inventors: Samuel Rapowitz, Roswell, GA (US); Viraj Chaudhary, Katy, TX (US); Joshua Edwards, Philadelphia, PA (US); Daniel Miller, Astoria, NY (US); David Septimus, New York, NY (US); Jenny Melendez, Falls Church, VA (US)

(21) Appl. No.: 17/363,979

(22) Filed: Jun. 30, 2021

(51) Int. Cl. G06Q 20/40; G06Q 20/38

(52) U.S. Cl. CPC G06Q 20/4014; G06Q 20/405; G06Q 20/407; G06Q 20/388

(57) ABSTRACT

Methods, systems, and apparatuses are described herein for improving computer authentication processes by dynamically adjusting questions presented during authentication. A request for access to an account may be received. A first authentication question may be generated based on a first transaction of a plurality of transactions associated with an account. Based on whether a response to the first authentication question is correct or not, a second or third transaction of the plurality of transactions may be selected, and a second authentication question might be generated based on the selected transaction. It may be determined whether to provide access to the account based on a response to the second authentication question.

### FIELD OF USE

Aspects of the disclosure relate generally to account security. More specifically, aspects of the disclosure may provide for improvements in the method in which authentication questions are generated by dynamically generating authentication questions based on previous responses to authentication questions.

### BACKGROUND

As part of determining whether to grant a user access to content (e.g., as part of determining whether to provide a caller access to a telephone system that provides banking information), a user of the user device might be prompted with one or more authentication questions. Such questions might relate to, for example, a password of the user, a personal identification number (PIN) of the user, or the like. Those questions might additionally and/or alternatively be generated based on personal information of the user. For example, when setting up an account, a user might provide a variety of answers to predetermined questions (e.g., “Where was your father born?,” “Who was your best friend in high school?”), and those questions might be presented to the user as part of an authentication process. As another example, a commercially-available database of personal information might be queried to determine personal information for a user (e.g., their birthdate, birth location, etc.), and that information might be used to generate an authentication question (e.g., “Where were you born, and in what year?”).

As part of authenticating a computing device, information about financial transactions conducted by a user of that computing device might be used to generate authentication questions as well. For example, a user might be asked questions about one or more transactions conducted by the user in the past (e.g., “Where did you get coffee yesterday?,” “How much did you spend on coffee yesterday?,” or the like). Such questions might prompt a user to provide a textual answer (e.g., by inputting an answer in a text field), to select one of a plurality of answers (e.g., select a single correct answer from a plurality of candidate answers), or the like. In some instances, the user might be asked about transactions that they did not conduct. For example, a computing device might generate a synthetic transaction (that is, a fake transaction that was never conducted by a user), and ask a user to confirm whether or not they conducted that transaction. Authentication questions can be significantly more useful when they can be based on either real transactions or synthetic transactions: after all, if every question related to a real transaction, a nefarious user could use personal knowledge of a legitimate user to guess the answer, and/or the nefarious user might be able to glean personal information about the legitimate user.

It may be ideal to make an authentication process easy for legitimate users and difficult for potentially unauthorized users (e.g., users potentially trying to gain malicious/unauthorized access to an account). This balance can be difficult to strike: authentication questions must be sufficiently difficult such that they cannot be easily guessed, but excessively difficult questions can be hard for even genuine/authorized users to answer. Indeed, in some instances, an authorization process can become so lengthy and difficult that it might discourage genuine users from trying to authenticate. For example, if a legitimate user must endure a laborious process of answering multiple questions to access their financial account, this laborious process might discourage them from regularly logging in to the financial account to check their transaction records, meaning that the legitimate user could possibly miss errors in their financial transaction histories.

Aspects described herein may address these and other problems, and generally improve the safety of financial accounts and computer transaction systems by dynamically generating and using authentication questions.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for improvements in the manner in which authentication questions are used to control access to accounts. The improvements described herein relate to the dynamic generation of authentication questions based on responses to previous authentication questions. By generating subsequent authentication questions based on whether answers to previous authentication questions were correct, a computing device might be able to expedite the authentication process for legitimate users that answer questions correctly while simultaneously providing robust/difficult authentication questions in circumstances where users might be trying to maliciously access an account (as evidenced by, e.g., their answers to authentication questions being incorrect).

More particularly, some aspects described herein may provide for a computing device that may receive, from a user device, a request for access to an account associated with a user. The computing device may retrieve transaction data for the account. The transaction data may indicate a plurality of transactions associated with the account. The computing device may generate, based on a first transaction of the plurality of transactions, a first authentication question, at least one correct answer to the first authentication question, and at least one incorrect answer to the first authentication question. The computing device may receive, from the user device, a response to the first authentication question. The computing device may select either a second transaction or a third transaction, of the plurality of transactions, to generate a second authentication question based on whether the response to the first authentication question is correct or not. The computing device may generate, based on the selected transaction, a second authentication question, at least one correct answer to the second authentication question, and at least one incorrect answer to the second authentication question. The computing device may receive, from the user device, a response to the second authentication question. The computing device may determine, based on the response to the first authentication question and on the response to the second authentication question, whether to provide access to the account.

According to some embodiments, the computing device may determine a merchant category code of the first transaction. In that circumstance, the second transaction might not have the same merchant category code, and the third transaction may have the same merchant category code. The second transaction may be the selected transaction when the response to the first authentication question is incorrect, whereas the third transaction may be the selected transaction when the response to the first authentication question is correct. The computing device may further determine that the first transaction is a recurring transaction, wherein the second transaction is not a recurring transaction. In that circumstance, the third transaction may be a recurring transaction. The computing device may determine that a payment card was not present for the first transaction. In that circumstance, the payment card might not have been present for the second transaction, and the payment card might have been present for the third transaction. The computing device may determine whether to provide access to the account based on determining to deny access to the account. In that circumstance, the computing device may then generate additional authentication questions until a minimum number of authentication questions has been generated and provide the additional authentication questions to the user. The computing device may calculate, based at least on the response to the first authentication question and the response to the second authentication question, a percentage of questions answered correctly and compare the percentage to a failure threshold and to a success threshold. In that circumstance, based on determining that the percentage is higher than the failure threshold and lower than the success threshold, the computing device may generate additional authentication questions. The computing device may calculate, based at least on the response to the first authentication question and the response to the second authentication question, a percentage of questions answered correctly and determine that a maximum number of questions has been generated. In that circumstance, the computing device may compare the percentage to a failure threshold and to a success threshold and, based on determining that the percentage is higher than the failure threshold and lower than the success threshold, deny access to the account.

Corresponding method, apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure;

FIG. 3 depicts a system comprising different computing devices that may be used in implementing one or more aspects of the disclosure in accordance with one or more illustrative aspects discussed herein;

FIG. 4 depicts a flow chart comprising steps which may be performed for generating and presenting authentication questions; and

FIG. 5 depicts examples of authentication questions.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for improving the manner in which authentication questions are generated and used during an authentication process. In particular, the process depicted herein may dynamically generate subsequent authentication questions based on the answer to previous authentication questions in a manner which may make the overall authentication process stronger to protect against unauthorized access, but which also may make the overall authentication process easier for legitimate users.

As an example of one process that may be improved by techniques described in the current disclosure, an authentication system could potentially, as part of an authentication process for accessing an account, generate a plurality of different authentication questions (e.g., ten questions) based on a transaction history for an account, then present those different authentication questions to a user as part of an authentication process. While this may be a particularly secure process in that the questions might be difficult for an unauthorized user to guess, the process might be unintentionally laborious and/or annoying to an authorized user. For instance, an authentication process that requires that a user correctly answer ten different questions to gain access to an account might be secure, but the process might be so laborious so as to discourage genuine users from trying to log in. Aspects described herein may improve on this process while still maintaining a high level of security.

Aspects described herein remedy this problem by, among other things, dynamically generating and presenting subsequent authentication questions based on how previous authentication questions were answered. As will be described below, based on whether a user answered a previous authentication question correctly or incorrectly, either a second transaction or third transaction might be selected. Based on that selection, a different authentication question might be generated. For example, if a user answered a previous authentication question correctly, a relatively simple transaction (e.g., a recurring transaction, a card-not-present transaction) might be selected, and a relatively easy authentication question might be generated based on that transaction. Additionally and/or alternatively, if a user answered a previous question correctly, a similar type of transaction may be selected, and an authentication question might be generated based on the similar transaction, because the user might find that type of transaction to be more memorable. This might, in effect, make the overall authentication process easier for legitimate users. In contrast, if a user answered a previous authentication question incorrectly, a more complicated transaction might be selected (e.g., one with a different Merchant Category Code (MCC), a non-recurring transaction, a card-present transaction), and a relatively more difficult authentication question might be generated based on that transaction. Additionally or alternatively, if a user answered a previous question incorrectly, a different type of transaction may be selected, and an authentication question might be generated for the different transaction, because the user found the previous transaction to be difficult to remember. In this manner, the authentication process might add difficulty if previous answers suggest that a requesting user might be trying to gain unauthorized access to an account and/or ask different types of questions in order to prevent making the process too difficult for a user who simply forgot about a particular transaction (e.g., because that particular transaction was not memorable for that user).

Aspects described herein improve the functioning of computers by improving the way in which computers provide authentication questions and protect computer-implemented accounts. The speed and processing complexity of computing devices allows them to store and process more and more customer data, which opens many potential security holes, but also allows the computing devices to present more complicated authentications than ever before, which advantageously can improve the security of sensitive account information. That said, the algorithms with which authentication questions are generated can have security holes, which might render those authentication questions undesirably vulnerable to exploitation. In general, the advancing complexity of computing systems creates a continual struggle to improve authentication systems while malicious actors attempt to find new ways to get around them. Such exploitation can result in the illegitimate use and abuse of computer resources. The processes described herein advance the state of the art by more dynamically generating and presenting authentication questions in a manner which is difficult for malicious users to guess, thereby improving the safety of authentication questions. At the same time, the process described herein might also be easy for legitimate users to complete, meaning that the computerized process is significantly more efficient for legitimate users. Such steps cannot be performed by a user and/or via pen and paper at least because the problem is fundamentally rooted in computing processes, involves a significantly complex amount of data and word processing to dynamically adjust the authentication process on-the-fly, and requires steps (e.g., authenticating computerized requests for access) which cannot be performed by a human being.

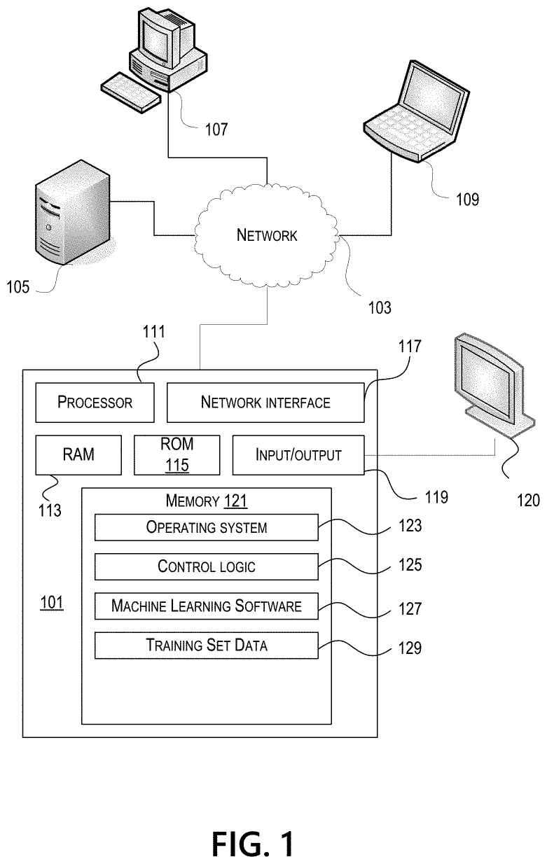

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, and training set data 129. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

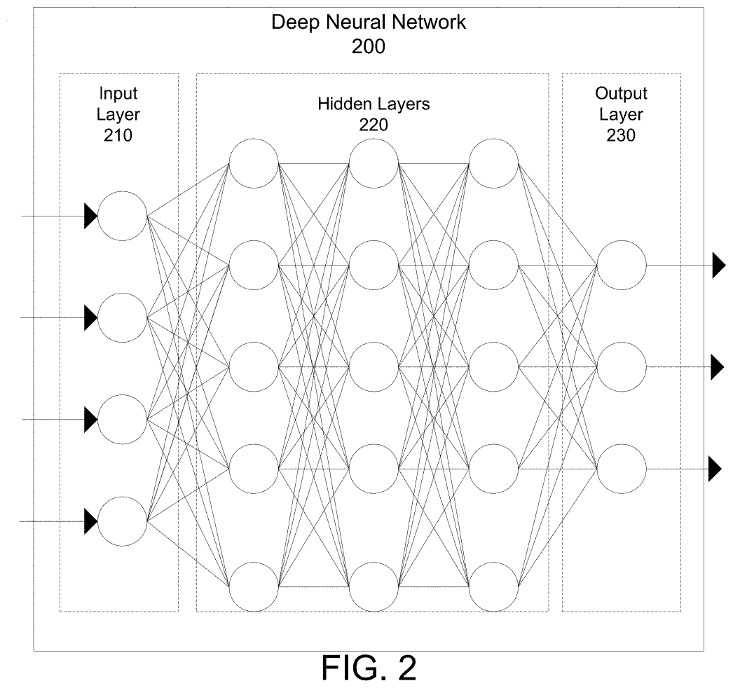

FIG. 2 illustrates an example deep neural network architecture 200. Such a deep neural network architecture might be all or portions of the machine learning software 127 shown in FIG. 1. That said, the architecture depicted in FIG. 2 need not be performed on a single computing device, and might be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

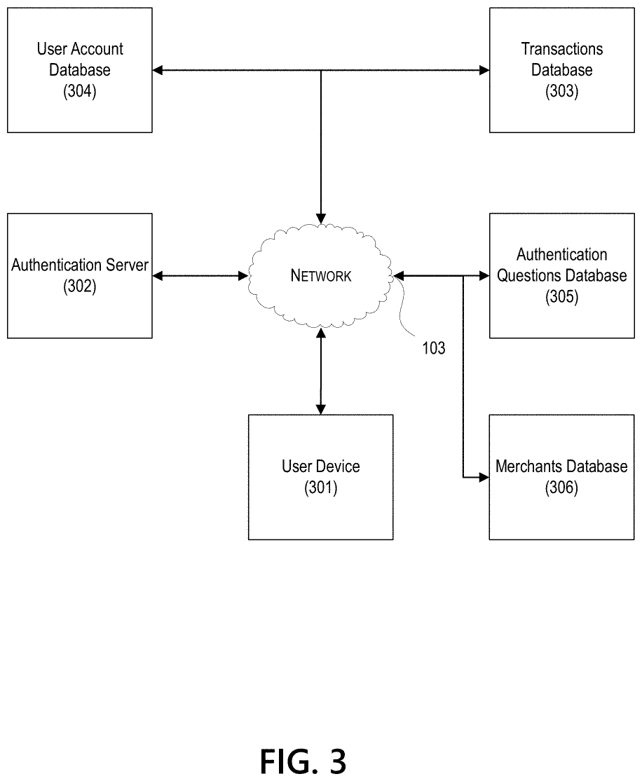

FIG. 3 depicts a system for authenticating a user device 301. The user device 301 is shown as connected, via the network 103, to an authentication server 302, a transactions database 303, a user account database 304, an authentication questions database 305, and an merchants database 306. The network 103 may be the same or similar as the network 103 of FIG. 1. Each of the user device 301, the authentication server 302, the transactions database 303, the user account database 304, the authentication questions database 305, and/or the merchants database 306 may be one or more computing devices, such as a computing device comprising one or more processors and memory storing instructions that, when executed by the one or more processors, perform one or more steps as described further herein. For example, any of those devices might be the same or similar as the computing devices 101, 105, 107, and 109 of FIG. 1.

As part of an authentication process, the user device 301 might communicate, via the network 103, to access the authentication server 302 to request access (e.g., to a user account). The user device 301 shown here might be a smartphone, laptop, or the like, and the nature of the communications between the two might be via the Internet, a phone call, or the like. For example, the user device 301 might access a website associated with the authentication server 302, and the user device 301 might provide (e.g., over the Internet and by filling out an online form) candidate authentication credentials to that website. The authentication server 302 may then determine whether the authentication credentials are valid. For example, the authentication server 302 might compare the candidate authentication credentials received from the user device 301 with authentication credentials stored by the user account database 304. In the case where the communication is telephonic, the user device 301 need not be a computing device, but might be, e.g., a conventional telephone.

The user account database 304 may store information about one or more user accounts, such as a username, password, demographic data about a user of the account, or the like. For example, as part of creating an account, a user might provide a username, a password, and/or one or more answers to predetermined authentication questions (e.g., “What is the name of your childhood dog?”), and this information might be stored by the user account database 304. The authentication server 302 might use this data to generate authentication questions. The user account database 304 might store demographic data about a user, such as their age, gender, location, occupation, education level, income level, and/or the like.

The transactions database 303 might comprise data relating to one or more transactions conducted by one or more financial accounts associated with a first organization. For example, the transactions database 303 might maintain all or portions of a general ledger for various financial accounts associated with one or more users at a particular financial institution. The data stored by the transactions database 303 may indicate one or more merchants (e.g., where funds were spent), an amount spent (e.g., in one or more currencies), a date and/or time (e.g., when funds were spent), or the like. The data stored by the transactions database 303 might be generated based on one or more transactions conducted by one or more users. For example, a new transaction entry might be stored in the transactions database 303 based on a user purchasing an item at a store online and/or in a physical store. As another example, a new transaction entry might be stored in the transactions database 303 based on a recurring charge (e.g., a subscription fee) being charged to a financial account. As will be described further below, synthetic transactions might be based, in whole or in part, on legitimate transactions reflected in data stored by the transactions database 303. In this way, the synthetic transactions might better emulate real transactions.

The account data stored by the user account database 304 and the transactions database 303 may, but need not be related. For example, the account data stored by the user account database 304 might correspond to a user account for a bank website, whereas the financial account data stored by the transactions database 303 might be for a variety of financial accounts (e.g., credit cards, checking accounts, savings accounts) managed by the bank. As such, a single user account might provide access to one or more different financial accounts, and the accounts need not be the same. For example, a user account might be identified by a username and/or password combination, whereas a financial account might be identified using a unique number or series of characters.

The authentication questions database 305 may comprise data which enables the authentication server 302 to present authentication questions. An authentication question may be any question presented to one or more users to determine whether the user is authorized to access an account. For example, the question might be related to personal information about the user (e.g., as reflected by data stored in the user account database 304), might be related to past transactions of the user (e.g., as reflected by data stored by the transactions database 303), or the like. The authentication questions database 305 might be used for dynamic authentications questions, such as questions dynamically generated for a particular authentication session and/or generated based on information corresponding to a particular account. The authentication questions database 305 might comprise data for one or more templates which may be used to generate an authentication question based on real information (e.g., from the user account database 304 and/or the transactions database 303) and/or based on synthetic information (e.g., synthetic transactions which have been randomly generated and which do not reflect real transactions). The authentication questions database 305 might additionally and/or alternatively comprise historical authentication questions. For example, the authentication questions database 305 might comprise code that, when executed, randomly generates an authentication question, then stores that randomly-generated authentication question for use with other users.

An authentication question might correspond to a synthetic transaction (e.g., a transaction which never occurred). For example, a synthetic transaction indicating a $10 purchase at a coffee shop on Wednesday might be randomly generated, and the authentication question could be, e.g., “Where did you spent $10 last Wednesday?,” “How much did you spend at the coffee shop last Wednesday?,” or the like. In all such questions, the correct answer might indicate that the user never conducted the transaction. As part of generating authentication questions based on synthetic transactions, organizations might be randomly selected from a list of organizations stored by the merchants database 306. Additionally and/or alternatively, as part of generating such authentication questions based on synthetic transactions, real transactions (e.g., as stored in the transactions database 303) might be analyzed. In this manner, real transactions might be used to make synthetic transactions appear more realistic.

The authentication questions stored in the authentication questions database 305 may be associated with varying levels of difficulty. For example, straightforward answers that should be easily answered by a user (e.g., “What is your mother's maiden name?”) might be considered easy questions, whereas complicated answers that require a user to remember past transactions (e.g., “How much did you spend on coffee yesterday?”) might be considered difficult questions. An authentication process might prompt a user to answer multiple authentication questions. For example, a user might be required to correctly answer three easy authentication questions and/or to answer one hard authentication question.

The merchants database 306 might store data relating to one or more merchants, including indications (e.g., names) of merchants, aliases of the merchants, and the like. That data might be used to generate authentication questions that comprise both correct answers (e.g., based on data from the transactions database 303 indicating one or more merchants where a user has in fact conducted a transaction) and synthetic transactions (e.g., based on data from the merchants database 306, which might be randomly-selected merchants where a user has not conducted a transaction). For example, a computing device might, as part of randomly generating a synthetic transaction using instructions provided by the authentication questions database 305, generate a synthetic transaction by querying the merchants database 306 for a list of merchants, then removing, from that list, organizations represented in the data stored by the transactions database 303.

Having discussed several examples of computing devices which may be used to implement some aspects as discussed further below, discussion will now turn to a method for dynamically presenting authentication questions during an authentication process.

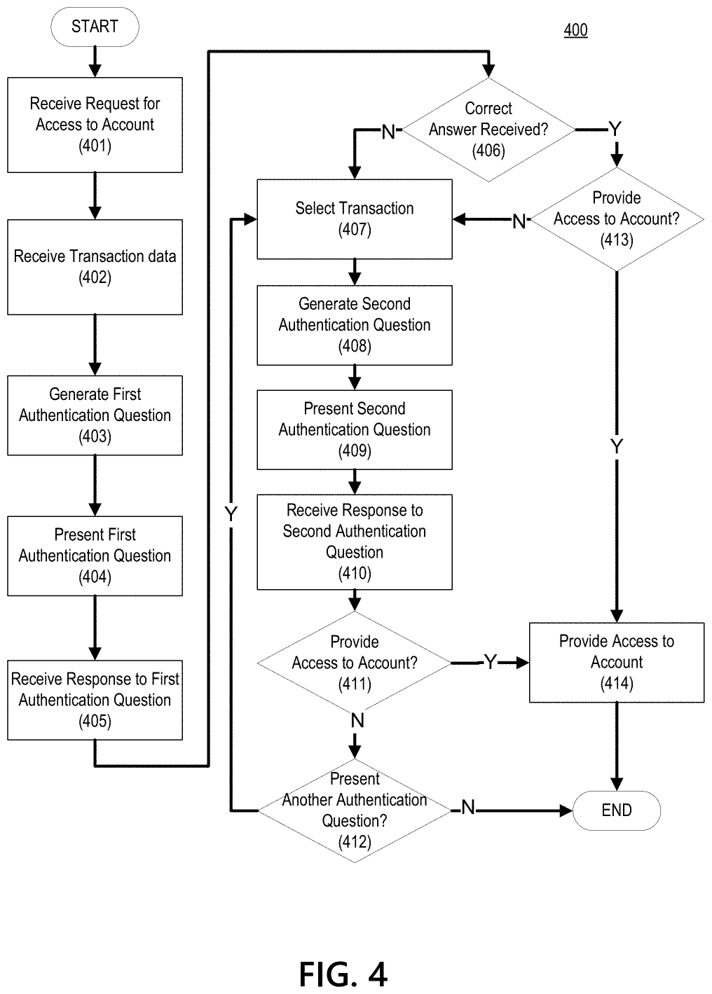

FIG. 4 illustrates an example method 400 for generating and presenting authentication questions in accordance with one or more aspects described herein. The method 400 may be implemented by a suitable computing system, as described further herein. For example, the method 400 may be implemented by any suitable computing environment by a computing device and/or combination of computing devices, such as one or more of the computing devices 101, 105, 107, and 109 of FIG. 1, and/or any computing device comprising one or more processors and memory storing instructions that, when executed by the one or more processors, cause the performance of one or more of the steps of FIG. 4. The method 400 may be implemented in suitable program instructions, such as in machine learning software 127, and may operate on a suitable training set, such as training set data 129. The method 400 may be implemented by computer-readable media that stores instructions that, when executed, cause performance of all or portions of the method 400. The steps shown in the method 400 are illustrative, and may be re-arranged, omitted, and/or otherwise modified as desired.

In step 401, the computing device may receive a request for access to an account. For example, the computing device may receive, from a user device, a request for access to an account associated with a user. The request may be associated with access, by a user, to a website, an application, or the like. The request may additionally and/or alternatively be associated with, for example, a user device calling into an IVR system or similar telephone response system. For example, the computing device may receive an indication of a request for access to an account responsive to a user accessing a log-in page, calling a specific telephone number, or the like. The request may specifically identify an account via, for example, an account number, a username, or the like. For example, a user might call an IVR system and be identified (e.g., using caller ID) by their telephone number, which might be used to query the user account database 304 for a corresponding account.

In step 402, the computing device may receive transaction data. The transaction data might correspond to the account referenced in step 401. For example, the computing device may retrieve transaction data for the account. The transaction data may be received from, e.g., the transactions database 303. The transactions data may indicate one or more transactions conducted by the user and/or may indicate a plurality of transactions associated with the account. For example, the transactions data may comprise indications of purchases of goods and/or services made by a user. The transactions data might correspond to a period of time, such as a recent period of time (e.g., the last two months, the last four months, or the like).

In step 403, the computing device may generate a first authentication question. The first authentication question might be based on a first transaction, such as might be indicated by the transaction data received in step 402. The first authentication question might comprise a prompt (e.g., “How much did you spend on gas last week?”) and one or more answers, including a correct answer (e.g., “$20”) and one or more incorrect answers (e.g., “$40,” “$1”). For example, the computing device may generate, based on a first transaction of a plurality of transactions, a first authentication question, at least one correct answer to the first authentication question, and at least one incorrect answer to the first authentication question. The first authentication question might be associated with a first level of difficulty. For example, the first authentication question might be a relatively standard authentication question that is neither particularly hard or particularly easy.

The first authentication question may be generated based on any aspect associated with a particular transaction or transactions stored in the transactions database 303. An authentication question may present the details of a single transaction (whether real or synthetic) and then ask the user if they recognize the transaction. For example, the question may ask whether the user spent a particular sum at a particular merchant at a particular time. Additionally and/or alternatively, the computing device may select a particular aspect of one or more transactions and generate an authentication question based on that selected aspect. For example, an authentication question may ask how much the user spent at a particular type of merchant during a particular period (e.g., based on several transactions with merchants of the merchant type during the particular period), whether the user was at a particular location at a particular time (e.g., as evidenced by transaction data), whether the user conducted any transactions with a particular merchant and/or type of merchant during a given period, and other such variations. Generating the authentication question may involve processing data associated with multiple transactions (e.g., calculating a total spent at a particular type of merchant over a particular period). For example, an authentication question might ask a user how much they spend, on average, at coffee shops.

The computing device may generate a user-specific difficulty rating associated with each question. The user-specific difficulty rating may be generated based on data associated with past authentication attempts, and in particular based on past answers to past authentication questions. For example, one user may have difficulty remembering certain types of transactions, such as which gas station they purchased gas from on any given week, because that user tends to shop around for gas and/or otherwise visit different gas stations. Such a user may thus tend to incorrectly answer authentication questions about gas stations. Accordingly, if the user has, in the past, missed one or more authentication questions about gas stations, then a question about which gas station the user purchased gas from may be rated more difficult for that user. Conversely, if the user has, in the past, answered several questions of a certain type correctly, that type of question may be rated easier for that user.

User-specific difficulty factors may be generated based on different aspects of authentication questions. A user-specific difficulty factor may be generated for every type of merchant (e.g., a first user-specific difficulty factor for gas stations, a second user-specific difficulty factor for grocery stores, etc.). Default values may be used if no data is available for a given user. Additionally and/or alternatively, user-specific difficulty factors may be generated based on other transaction attributes. For example, one user-specific difficulty factor may be generated for transactions at a first location, another for transactions at a second location, and the like. The computing device may generate a user-specific difficulty rating for a question by averaging any user-specific difficulty factor that applies to a particular question. For example, for a question about whether a user conducted a transaction of a particular amount at a particular merchant at a particular time, the computing device might generate the user-specific difficulty rating for the question based on user-specific difficulty factors for the merchant, for the merchant type, for the amount spent, for the location of the merchant, for the day of week, for the time of day, and the like. The computing device may generate the user-specific difficulty rating by averaging the user-specific difficulty factor (e.g., using a weighted average that assigns more weight to the most difficult factors as one example strategy).

Accordingly, user-specific difficulty ratings may be generated for each question based on a user's previous answers to questions. These user-specific difficulty ratings may be considered when generating the first authentication question: for example, as stated above, the computing device may generate a first authentication question that is neither too difficult nor too easy for the specific user.

In step 404, the computing device may present the first authentication question. Causing presentation of the authentication question may comprise causing one or more computing devices to display and/or otherwise output the authentication question. For example, the computing device may transmit information for presenting the authentication question to a user computing device. The authentication question might be provided in a text format (e.g., in text on a website), in an audio format (e.g., over a telephone call), or the like.

In step 405, the computing device may receive a response to the first authentication question. For example, the computing device may receive, from the user device, a response to the first authentication question. A response may be any indication of a response, by a user, to the first authentication question presented in step 404. For example, if the first authentication question comprises one or more answers from which the user should select, the response might comprise a selection of at least one of the one or more answers. As another example, in the case of a telephone call, the response might comprise an oral response to an authentication question provided using a text-to-speech system over the call.

In step 406, the computing device may determine whether the response received in step 405 is correct. Determining whether the response received in step 405 is correct might comprise comparing the answer received in step 405 to a correct answer generated in step 403. If the answer is incorrect, the method 400 proceeds to step 407. If the answer is correct, the method 400 proceeds to step 413.

As a general introduction to steps 407 through 411, once a first authentication question has been presented, it may be desirable to present a second authentication question. In particular, the second authentication question might be generated based on the response received to the first authentication question (e.g., as received in step 405). For example, if a user easily and correctly answered a previous authentication question, the next authentication question might be generated to be slightly harder so as to prevent all questions presented to the user from being easily guessable. Additionally and/or alternatively (e.g., if sufficient user data is available to generate a user-specific difficulty rating for a second question), the second authentication question may be generated such that it may be easier for that user, but harder for other users (e.g., the user-specific difficulty rating may diverge from a default difficulty rating generated based on default difficult factors). As another example, if a user incorrectly answered a previous question (e.g., one relating to an amount they spent on gas), a different type of question (e.g., one relating to selecting a restaurant they dined at last week) might be generated so as to ensure that the questions are sufficiently diverse and do not inadvertently confuse a user (e.g., that might not pay much attention at the gas pump). At the same time, the user-specific difficulty data may be updated based on the incorrect answer so as to make it less likely that similar questions may be asked to that user in the future. This may advantageously make the authentication process friendlier and easier for legitimate users, while also providing a more difficult authentication process for potentially malicious users. As will be also described below with respect to step 413, a second authentication question might be generated even if a user answered the first authentication question correctly: for instance, a user device might be required to correctly answer a particular number of questions (and, e.g., get at least a threshold percentage of those questions correct) before being provided access to an account.

In step 407, the computing device may select a transaction. The transaction might be selected based on the response received in step 405. For example, the computing device may, based on whether the response to the first authentication question is correct or not, select either a second transaction or a third transaction, of the plurality of transactions, to generate a second authentication question. The second transaction might be selected when the response received in step 405 is incorrect, whereas the third transaction might be selected when the response received in step 405 is correct. The second transaction and the third transaction might be different in a number of ways: they might involve different time periods, different merchants, different goods and/or services, different authorized users, or the like. In some cases, the computing device may decide whether to generate a second authentication question based on one plurality of transactions that include the second transaction or based on another plurality of transactions that include the third transaction.

The selected transaction or transactions might be associated with a different merchant (and, e.g., a different merchant category) as compared to the first transaction upon which the first authentication question was based. It may be desirable to vary the types of transactions upon which authentication questions are based. For instance, if a user answered a previous question incorrectly, it may be desirable to select a different transaction (e.g., from a different type of merchant), as the user might simply have trouble remembering certain types of transactions (e.g., relatively inconsequential transactions, such as for snacks at a corner store). Thus, relevant user-specific difficulty factors for the particular transaction that was answered incorrectly may be updated, leading to the selection of different types of transactions for future questions. In this manner, the computing device might be configured to determine whether to vary the merchant category of a transaction based on whether a previous authentication question was answered correctly or not. The computing device may determine a merchant category code of the first transaction. For example, the computing device might determine that a merchant category code of a first transaction indicates that the transaction related to a fuel purchase, such that the first authentication question (e.g., generated based on that first transaction) related to the fuel purchase. In that circumstance, the second transaction might not have the same merchant category code (e.g., it might relate to a coffee purchase), but the third transaction might the same merchant category code (e.g., it might relate to another fuel purchase). The second transaction (e.g., with a different merchant category code) might be the selected transaction when the response to the first authentication question is incorrect. In that way, if a legitimate user has difficulty answering questions about a certain category of transactions (e.g., fuel transactions), that difficulty need not prevent them from accessing their account, as subsequent authentication questions might relate to a different type of transaction. In contrast, the third transaction (e.g., with the same merchant category code as compared to the first transaction) might be the selected transaction when the response to the first authentication question is correct. In this way, if a legitimate user can easily answer questions about certain types of transactions (e.g., fuel purchases), they can be provided a series of related questions that they can easily answer to gain access to their account. Thus, the user-specific difficulty data may be updated and become more accurate as additional questions are answered, leading the computing device to ask questions that are easier for that user without compromising security.

The selected transaction might have a different transaction pattern from the first transaction upon which the first authentication question was based. It might be easier for users to answer questions regarding recurring transactions than it is for them to answer questions regarding occasional transactions. Again, the computing device may update a user-specific difficulty factor for recurring transactions and/or occasional transactions to reflect such a pattern based on the user's answers. The computing device thus may determine that the first transaction is a recurring transaction (e.g., a payment for an online subscription) and update the user-specific difficulty data accordingly. In that circumstance, the second transaction might not be a recurring transaction, but the third transaction might be a recurring transaction. The second transaction (e.g., relating to a non-recurring transaction) might be the selected transaction when the response to the first authentication question is incorrect. In that way, a different type of authentication question regarding a different type of transaction might be provided. Indeed, this might operate to increase the difficulty of the authentication question significantly for malicious users: if they have difficulty guessing an answer for an authentication question premised on a recurring transaction, it might be even more difficult for them to guess an answer for an authentication question premised on a one-time transaction. In contrast, the third transaction (e.g., with the recurring transaction) might be the selected transaction when the response to the first authentication question is correct. In this manner, a legitimate user might be able to quickly answer questions relating to their recurring transactions (e.g., their ongoing subscriptions) and gain access to their account.

The selected transaction might involve a different type of financial card use as compared to the first transaction upon which the first authentication question was based. Transactions involving the manual swipe of a credit card (and/or using chip-and-pin, near-field communication, or similar technologies) might be memorable in a different way than card-not-present transactions (e.g., online purchases). The computing device may determine that a payment card was not present for the first transaction and update a user-specific difficulty factor accordingly. For example, the first transaction (upon which the first authentication question was based) might be an online purchase. In that circumstance, the payment card might not have been present for the second transaction, but the payment card might have been present for the third transaction. The second transaction (e.g., a card-present transaction) might be the selected transaction when the response to the first authentication question is incorrect. In this way, for example, if the user is confused by an authentication question relating to an online purchase (an example of a card-not-present transaction), they might be provided a different authentication question relating to a physical purchase of goods and/or services at a store (a card-present transaction). In contrast, the third transaction (e.g., another card-not-present transaction) might be the selected transaction when the response to the first authentication question is correct. In this way, for example, if a legitimate user can easily remember the online purchases they've made recently, then they might be provided another such question so as to make their authentication process easier. That said, it may be desirable in some circumstances to intentionally vary card-present and card-not-present transactions. For example, because card-not-present transactions online might be associated with confirmatory e-mails (e.g., receipts received via e-mail), it might be desirable to occasionally ask about card present transactions in case a malicious user has gained unauthorized use to a legitimate user's e-mail account (and, e.g., can use that access to look up the answer to authentication questions relating to online purchases).

In step 408, the computing device may generate a second authentication question. This step might be the same or similar as step 403, except that the second authentication question might be generated based on the transaction selected in step 407. For example, the computing device may generate, based on the selected transaction, a second authentication question, at least one correct answer to the second authentication question, and at least one incorrect answer to the second authentication question.

The second authentication question might be generated using a machine learning model. A machine learning model (e.g., as implemented by the machine learning software 127 and/or via the deep neural network 200) may be used to generate subsequent authentication questions (e.g., the second authentication question generated in step 410) using data such as the transaction selected in step 407, the first authentication question generated in step 403, and the response received in step 405. For example, a machine learning model may be trained to generate authentication questions using training data that indicates a history of authentication questions, successful or unsuccessful answers by users (e.g., whether users got the questions correct or incorrect), and the ordering in which those authentication questions were presented to users (e.g., if one authentication question was presented after another). In this way, the machine learning model might learn, over time, which properties of questions make them harder or easier, particularly in conjunction with other previously-presented questions. In turn, the trained machine learning model might be provided, as input, the transaction selected in step 407, the first authentication question generated in step 403, and/or the response received in step 405. The computing device might then receive, as output, a suggested authentication question.

In step 409, the computing device may present the second authentication question. This step may be the same or similar as step 404, except the second authentication question generated in step 408 might be presented.

In step 410, the computing device may receive a response to the second authentication question. This step may be the same or similar as step 405, except that the response might relate to the second authentication question. For example, the computing device may receive, from the user device, a response to the second authentication question.

In step 411, the computing device may determine, based on the response received in step 410, whether to provide access to the account. Determining whether to provide access to the account may be based on whether the response received in step 410 is correct. As such, step 411 may be similar to step 406 in that the response received in step 410 might be compared to a correct answer determined as part of generating the second authentication question in step 408. Determining whether to provide access to the account might be based on both the response received in step 405 (e.g., whether it is correct) as well as whether any previous response(s) (e.g., the response received in step 405) were correct. For example, the computing device may determine, based on the response to the first authentication question and on the response to the second authentication question, whether to provide access to the account. If the computing device decides to not provide access to the account, the method 400 may proceed to step 412. If the computing device decides to provide access to the account, the method 400 may proceed to step 414.

Determining whether to provide access to the account may be based on a percentage of authentication questions answered correctly. The computing device may calculate, based at least on the response to the first authentication question and the response to the second authentication question, a percentage of questions answered correctly. For example, if a user answered both authentication questions correctly, the percentage might be 100%, whereas if the user only answered one of the two authentication questions correctly, the percentage might be 50%. The computing device may compare the percentage to a failure threshold and to a success threshold. For example, a success threshold might be any value over 60%, whereas a failure threshold might be equal to or less than 40%, with values between 41% and 59% causing another question to be generated (as part of step 412, discussed below). In some instances, based on determining that the percentage does not satisfy the success threshold (e.g., is not over 60%) and satisfies the failure threshold (e.g., is equal to or less than 40%), the computing device may deny access to the account without generating additional questions (as part of step 412, discussed below).

Determining whether to provide access to the account may be based on output from a machine learning model. A machine learning model (e.g., as implemented by the machine learning software 127 and/or via the deep neural network 200) may be used to evaluate, based on the difficulty of authentication questions and whether users answered them correctly, whether to provide the user access to an account. To train the machine learning model to perform this task, the computing device may provide, to the machine learning model, training data comprising a history of log-in attempts by users wherein, during those log-in attempts, the users provided correct and/or incorrect answers to one or more authentication questions of varying difficulty. Such training data might be tagged as either reflective of activity by a legitimate (e.g., authorized) user or a malicious user. Such training data might additionally and/or alternatively comprise the location of the user(s), the time in which the question(s) were answered, and/or the like. In this manner, the trained machine learning model might learn to identify, based on a pattern of responses by a user to a series of authentication questions of varying difficulty, whether login activity is indicative of activity by a legitimate user or an unauthorized user. In turn, the trained machine learning model might be provided input data comprising an indication of the difficulty of the generated authentication questions (e.g., as generated in step 403 and step 408) and whether the responses received in step 405 and 410 were correct. The trained machine learning model might additionally and/or alternatively be provided additional input reflective of a potential legitimacy of the user, such as the location of the user (e.g., as reflected by their Internet Protocol (IP) address, Global Positioning System (GPS) coordinates, or the like), a time of day when the request from step 401 was received, or the like. In response to the input data, the trained machine learning model might provide, as output, an indication of whether the computing device should provide access to the account.

In step 412, the computing device may determine whether to present another authentication question. Access to the account might be denied if a maximum number of authentication questions have been generated and/or presented. For example, the computing device may generate additional authentication questions until a minimum number of authentication questions has been generated. Those additional authentication questions might be presented to the user. As such, the process depicted in step 407 through step 410 might be repeated a number of times, such as a maximum number of times. For example, an administrator might set a maximum number of times to be five, meaning that a maximum of five authentication questions should be presented to a user during authentication. In such an example, the process depicted in step 407 through step 410 might be repeated a maximum of four times such that it generates four authentication questions (totaling five authentication questions in total in conjunction with the first authentication question generated in step 403). In this way, a user might in some circumstances be provided up to five different opportunities to answer an authentication question and be provided access to an account in step 411. If the answer to step 412 is yes (e.g., the computing device determines that the system should present another authentication question, such as where a maximum number of authentication questions has not yet been reached), the method 400 returns to step 407. Otherwise (e.g., if the maximum number of authentication questions has been generated and/or presented), the method 400 ends.

The answer to step 412 might additionally and/or alternatively be no even if the maximum number of authentication questions has not yet been reached if the percentage of correct answers determined in step 411 is sufficiently low. For example, if the user is unable to answer either the first authentication question or the second authentication question correctly, the computing device might determine to not present another authentication question. After all, if a user has already failed two authentication questions, it might not be worthwhile to present additional authentication questions, even if the maximum number of authentication questions has not yet been reached.

As one example of step 411 and step 412, based on determining that the percentage determined satisfies the failure threshold and does not satisfy the success threshold (as part of step 411), and based on determining the maximum number of authentication questions has not yet been reached and/or that a minimum number of authentication questions have not yet been presented (as part of step 412), the computing device may generate additional authentication questions by returning to step 407 of the method 400. In this manner, the computing device may be configured to, for example, present authentication questions until the user either successfully authenticates using presented authentication questions or fails to answer a satisfactory percentage of authentication questions.

In step 413, which may occur if the correct answer was received for the first authentication question as determined in step 406, the computing device may determine whether to provide access to the account. This step may be the same or similar as step 411, discussed above. In this manner, step 413 reflects that, in certain circumstances, the first authentication question might be particularly difficult such that, if the user correctly answers it, access might be granted based on a single answer alone. If the answer to step 413 is no, the method 400 proceeds to step 407, such that a transaction might be selected and a second authentication question might be generated and presented. If the answer to step 413 is yes, the method 400 proceeds to step 414, where access to the account is provided.

In step 414, the computing device may provide access to the account. For example, the computing device may provide a user device access to the account. Access to the account might be provided by, e.g., providing a user device access to a protected portion of a website, transmitting confidential data to a user device, allowing a user to request, modify, and/or receive personal data (e.g., from the user account database 304 and/or the transactions database 303), or the like.

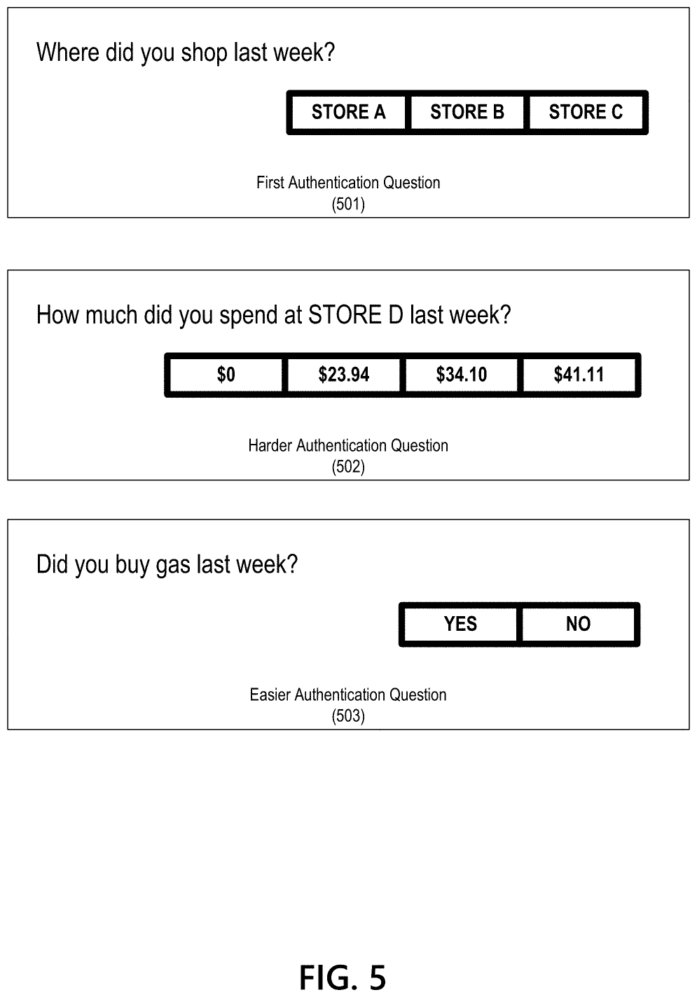

FIG. 5 shows examples of authentication questions which might be generated by the computing device when performing the method 400 of FIG. 4. Particularly, FIG. 5 depicts a first authentication question 501, a harder authentication question 502, and an easier authentication question 503.

The first authentication question 501 might have been generated as part of step 403 of the method 400 of FIG. 4. In this example, the first authentication question 501 asks a user where they shopped last week, and provides three options (“Store A,” “Store B,” and “Store C”). In this circumstance, the underlying transaction upon which the first authentication question 501 is premised might be, for example, a transaction at Store B. Accordingly, the correct answer might be the answer “Store B,” with the other answers being incorrect.

The harder authentication question 502 is one example of a second authentication question, such as one that has been generated as part of step 408 of the method 400 of FIG. 4. In this example, the harder authentication question 502 asks a user how much they spent at “Store D” last week, with four potential options with specific monetary values. In this example, the question is harder because it requires that a user answer a specific dollar value. Moreover, the harder authentication question 502 may be premised on a transaction that might be harder for an unauthorized user to guess: for example, the transaction might be a single (e.g., not recurring), card-present transaction. Additionally and/or alternatively, the question may be relatively easier for the authorized user to answer correctly, for example based on a user-specific difficulty rating for the question indicating that the question is relatively easy for the user. As discussed above, such aspects of the transaction might make authentication questions based on that transaction (e.g., the harder authentication question 502) harder for a malicious user to guess without significantly burdening an authentic user.

The easier authentication question 503 is another example of a second authentication question, such as one that has been generated as part of step 408 of the method 400 of FIG. 4. In this example, the easier authentication question 503 asks a user whether they bought gas last week, with possible answers “Yes” and “No.” In this example, the question is easier because it requires that a user confirm whether they conducted a type of transaction, rather than identify a specific merchant or monetary amount. Such a question might be presented in circumstances where a user has previously answered questions correctly, but where, for example, a percentage of correct answers to authentication questions has not yet satisfied a success threshold. In this way, a seemingly-legitimate user might be provided slightly easier questions to answer based on their previous responses being correct. Additionally and/or alternatively, the question may be easier as indicated by a user-specific difficulty rating for that user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
receiving, by a computing device and from a user device, a request for access to an account associated with a user;
retrieving, by the computing device, transaction data for the account, wherein the transaction data indicates a plurality of transactions associated with the account;
generating, by the computing device, based on a first transaction of the plurality of transactions, a first authentication question, at least one correct answer to the first authentication question, and at least one incorrect answer to the first authentication question;
receiving, by the computing device and from the user device, a response to the first authentication question;
based on whether the response to the first authentication question is correct or not based on a user-specific difficulty level of questions associated with a second transaction, and based on a different user-specific difficulty level of questions associated with a third transaction, selecting either the second transaction or the third transaction, of the plurality of transactions, to generate a second authentication question, wherein the user-specific difficulty level of questions associated with the second transaction is based on data associated with past authentication attempts by the user;
generating, by the computing device, based on the selected transaction, a second authentication question, at least one correct answer to the second authentication question, and at least one incorrect answer to the second authentication question;
receiving, by the computing device and from the user device, a response to the second authentication question; and
determining, by the computing device, based on the response to the first authentication question and on the response to the second authentication question, whether to provide access to the account.

2. The method of claim 1, further comprising:
determining a merchant category code of the first transaction,
wherein the second transaction does not have the same merchant category code, wherein the third transaction has the same merchant category code.

3. The method of claim 2, wherein the second transaction is the selected transaction when the response to the first authentication question is incorrect, wherein the third transaction is the selected transaction when the response to the first authentication question is correct.

4. The method of claim 1, further comprising:
determining that the first transaction is a recurring transaction,
wherein the second transaction is not a recurring transaction, wherein the third transaction is a recurring transaction.

5. The method of claim 1, further comprising:
determining that a payment card was not present for the first transaction,
wherein the payment card was not present for the second transaction, wherein the payment card was present for the third transaction.

6. The method of claim 1, wherein the determining of whether to provide access to the account comprises determining to deny access to the account, further comprising:
generating additional authentication questions until a minimum number of authentication questions has been generated; and
providing the additional authentication questions to the user.

7. The method of claim 1, further comprising:
calculating, based at least on the response to the first authentication question and the response to the second authentication question, a percentage of questions answered correctly; and
comparing the percentage to a failure threshold and to a success threshold; and
based on determining that the percentage is higher than the failure threshold and lower than the success threshold, generating additional authentication questions.

8. The method of claim 1, further comprising:
calculating, based at least on the response to the first authentication question and the response to the second authentication question, a percentage of questions answered correctly;
determining that a maximum number of questions has been generated;
comparing the percentage to a failure threshold and to a success threshold; and
based on determining that the percentage is higher than the failure threshold and lower than the success threshold, denying access to the account.

9. A computing device comprising:
one or more processors; and
memory storing instructions that, when executed by the one or more processors, cause the computing device to:
receive, from a user device, a request for access to an account associated with a user;
retrieve transaction data for the account, wherein the transaction data indicates a plurality of transactions associated with the account;
generate, based on a first transaction of the plurality of transactions, a first authentication question, at least one correct answer to the first authentication question, and at least one incorrect answer to the first authentication question;
receive, from the user device, a response to the first authentication question;
based on whether the response to the first authentication question is correct or not, based on a user-specified difficulty level of questions associated with a second transaction and based on a different user-specific difficulty level of questions associated with a third transaction, select either the second transaction or the third transaction, of the plurality of transactions, to generate a second authentication question, wherein the user-specific difficulty level of questions associated with the second transaction is based on data associated with past authentication attempts by the user;
generate, based on the selected transaction, a second authentication question, at least one correct answer to the second authentication question, and at least one incorrect answer to the second authentication question;
receive, from the user device, a response to the second authentication question; and
determine, based on the response to the first authentication question and on the response to the second authentication question, whether to provide access to the account.

10. The computing device of claim 9, wherein the instructions, when executed by the one or more processors, further cause the computing device to:
determine a merchant category code of the first transaction,
wherein the second transaction does not have the same merchant category code, wherein the third transaction has the same merchant category code.

11. The computing device of claim 9, wherein the instructions, when executed by the one or more processors, further cause the computing device to:
determine that the first transaction is a non-recurring transaction,
wherein the second transaction is not a recurring transaction, wherein the third transaction is a recurring transaction.

12. The computing device of claim 9, wherein the instructions, when executed by the one or more processors, further cause the computing device to:
determine that a payment card was present for the first transaction,
wherein the payment card was not present for the second transaction, wherein the payment card was present for the third transaction.

13. The computing device of claim 9, wherein the instructions, when executed by the one or more processors, further cause the computing device to:
calculate, based at least on the response to the first authentication question and the response to the second authentication question, a percentage of questions answered correctly; and
compare the percentage to a failure threshold and to a success threshold; and
based on determining that the percentage is higher than the failure threshold and lower than the success threshold, generate additional authentication questions.

14. The computing device of claim 9, wherein the instructions, when executed by the one or more processors, further cause the computing device to:
calculate, based at least on the response to the first authentication question and the response to the second authentication question, a percentage of questions answered correctly;
determine that a maximum number of questions has been generated;
compare the percentage to a failure threshold and to a success threshold; and
based on determining that the percentage is higher than the failure threshold and lower than the success threshold, deny access to the account.

15. One or more non-transitory computer-readable media storing instructions that, when executed by one or more processors, cause a computing device to:
receive, from a user device, a request for access to an account associated with a user;
retrieve transaction data for the account, wherein the transaction data indicates a plurality of transactions associated with the account;
generate, based on a first transaction of the plurality of transactions, a first authentication question, at least one correct answer to the first authentication question, and at least one incorrect answer to the first authentication question;
receive, from the user device, a response to the first authentication question;
based on whether the response to the first authentication question is correct or not, based on a user-specific difficulty level of questions associated with a second transaction, and based on a different user-specific difficulty level of questions associated with a third transaction, select either the second transaction or the third transaction, of the plurality of transactions, to generate a second authentication question, wherein the user-specific difficulty level of questions associated with the second transaction is based on data associated with past authentication attempts by the user;
generate, based on the selected transaction, a second authentication question, at least one correct answer to the second authentication question, and at least one incorrect answer to the second authentication question;
receive, from the user device, a response to the second authentication question; and
determine, based on the response to the first authentication question and on the response to the second authentication question, whether to provide access to the account.

16. The one or more non-transitory computer-readable media of claim 15, wherein the instructions, when executed by the one or more processors, further cause the computing device to:
determine a merchant category code of the first transaction,
wherein the second transaction does not have the same merchant category code, wherein the third transaction has the same merchant category code.

17. The one or more non-transitory computer-readable media of claim 15, wherein the instructions, when executed by the one or more processors, further cause the computing device to:
determine that the first transaction is a recurring transaction,
wherein the second transaction is not a recurring transaction, wherein the third transaction is a recurring transaction.

18. The one or more non-transitory computer-readable media of claim 15, wherein the instructions, when executed by the one or more processors, further cause the computing device to:
determine that a payment card was not present for the first transaction,
wherein the payment card was not present for the second transaction, wherein the payment card was present for the third transaction.

19. The one or more non-transitory computer-readable media of claim 15, wherein the instructions, when executed by the one or more processors, further cause the computing device to:
calculate, based at least on the response to the first authentication question and the response to the second authentication question, a percentage of questions answered correctly; and
compare the percentage to a failure threshold and to a success threshold; and
based on determining that the percentage is higher than the failure threshold and lower than the success threshold, generate additional authentication questions.

20. The one or more non-transitory computer-readable media of claim 15, wherein the instructions, when executed by the one or more processors, further cause the computing device to:
calculate, based at least on the response to the first authentication question and the response to the second authentication question, a percentage of questions answered correctly;
determine that a maximum number of questions has been generated;
compare the percentage to a failure threshold and to a success threshold; and
based on determining that the percentage is higher than the failure threshold and lower than the success threshold, deny access to the account.
